(19) United States
(12) Patent Application Publication
(10) Pub. No.: US 2026/0007168 A1
(43) Pub. Date: Jan. 8, 2026

(54) COMBINABLE AND ORIENTABLE AEROSOLIZATION DEVICES, SYSTEMS, AND METHODS

(71) Applicant: Singular X, Inc., Las Vegas, NV (US)

(72) Inventor: Steven Hwang, San Rafael, CA (US)

(21) Appl. No.: 19/256,842

(22) Filed: Jul. 1, 2025

Related U.S. Application Data
(60) Provisional application No. 63/667,006, filed on Jul. 2, 2024.

(51) Int. Cl. A24F 40/40; A24F 40/10; A24F 40/51; A24F 40/57; A24F 40/65; A24F 40/95; H01F 7/02

(52) U.S. Cl. CPC A24F 40/40; H01F 7/0252; A24F 40/10; A24F 40/51; A24F 40/57; A24F 40/65; A24F 40/95

(57) ABSTRACT

This disclosure relates generally to aerosolization devices or vaping devices that are combinable and orientable with other aerosolization devices, such that a user may be provided with a plurality of aerosolization/vaping experiences. In various aspects, an aerosolization system includes a first aerosolization device having a plurality of dual-polarity magnets and a second aerosolization device having a plurality of dual-polarity magnets. The second aerosolization device may be substantially identical to the first aerosolization device. The second aerosolization device may be connectable to the first aerosolization device in four (4) orientations or positions.

### CLAIM FOR PRIORITY

This application claims the benefit of and priority to U.S. Provisional Application No. 63/667,006 filed on Jul. 2, 2024 and titled, “COMBINABLE AND ORIENTABLE VAPING DEVICES, SYSTEMS, AND METHODS,” the entire contents of which are herein incorporated by reference.

### TECHNICAL FIELD

This disclosure relates generally to aerosolization devices that are combinable and orientable with other vaping devices, such that a user may be provided with a plurality of vaping experiences.

### SUMMARY

Disclosed are systems, devices, and/or methods of use thereof regarding aerosolization devices or vaping devices that are combinable and orientable with other vaping devices, such that a user may be provided with a plurality of vaping experiences. In various aspects, an aerosolization device includes a housing having a rounded front portion and a substantially planar back portion in connection with the front portion. The aerosolization device also includes a mouthpiece in connection with the housing, the mouthpiece having a rounded front portion and a substantially planar back portion aligned with the substantially planar back portion of the housing. Further, the aerosolization device includes a plurality of magnets internally disposed within the housing, with each of the plurality of magnets having a dual polarity. The aerosolization device is capable of magnetic connection to a second vaping device in four (4) orientations, where the second vaping device is identical to the first vaping device.

In various aspects, a vaping system includes a first vaping device having a housing, a mouthpiece connected to the housing, and a plurality of dual-polarity magnets. The vaping system also includes a second vaping device connectable to the first vaping device in four (4) orientations. The second vaping device includes a housing, a mouthpiece connected to the housing, and a plurality of dual-polarity magnets for engaging the plurality of dual-polarity magnets of the first vaping device. The mouthpiece of the first vaping device is aligned with and adjacent to the mouthpiece of the second vaping device when the first vaping device is connected to the second vaping device in a first orientation. The mouthpiece of the first vaping device is opposite from and not adjacent to the mouthpiece of the second vaping device when the first vaping device is connected to the second vaping device in a second orientation. The mouthpiece of the first vaping device is orthogonal to the mouthpiece of the second vaping device in a first direction when the first vaping device is connected to the second vaping device in a third orientation. And, the mouthpiece of the first vaping device is orthogonal to the mouthpiece of the second vaping device in a second direction when the first vaping device is connected to the second vaping device in a fourth orientation, with the second direction being 180° away from the first direction.

In various aspects, a vaping system includes a first vaping device having a plurality of dual-polarity magnets and a second vaping device having a plurality of dual-polarity magnets. The second vaping device may be substantially identical to the first vaping device. The second vaping device may be connectable to the first vaping device in four (4) orientations or positions.

In various aspects, a method of vaping includes connecting a first vaping device to a second vaping device in a first orientation, such that a mouthpiece of the first vaping device is adjacent to a mouthpiece of the second vaping device, and vaping from the first vaping device and the second vaping device simultaneously. The method may also include orienting the first vaping device and the second vaping device in a second orientation, such that the mouthpiece of the first vaping device is not adjacent to the mouthpiece of the second vaping device. Further, the method includes vaping from the first vaping device separately from the second vaping device.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

In the drawings:

FIG. 1 illustrates a front view of an aerosolization device according to the present disclosure;

FIG. 2 illustrates a back view of the aerosolization device of FIG. 1;

FIG. 3 illustrates a side view of the aerosolization device of FIG. 1;

FIG. 4 illustrates an exploded view of the aerosolization device of FIG. 1;

FIG. 5A illustrates a top, perspective view of a vaping system in a first configuration and FIG. 5B illustrates a back perspective view of the vaping system in the first configuration;

FIG. 6A illustrates one orientation of a plurality of magnets of each vaping device from the vaping system of FIGS. 5A and 5B;

FIG. 6B illustrates another orientation of a plurality of magnets of each vaping device from the vaping system of FIGS. 5A and 5B;

FIG. 7A illustrates the vaping system of FIGS. 5A and 5B in a second configuration and FIG. 7B illustrates the vaping system of FIGS. 5A and 5B in a third configuration;

FIGS. 8A and 8B illustrate the vaping system of FIGS. 5A and 5B in a fourth configuration;

FIG. 9 schematically illustrates a block diagram of a controller for use with An aerosolization device and/or a vaping system of the present disclosure; and

FIG. 10 is a flowchart of an example method of vaping according to the present disclosure.

### DETAILED DESCRIPTION

Users of aerosolization devices or vaping devices can customize their vaping experience in a variety of ways. Users can create custom pre-vapor formulations, use different vaping devices for vaping different liquids or oils (e.g., pre-vapor formulations), use vaping devices implementing different vaping techniques (conduction or convection), etc. Even with such vaping option variety, users continue to search for additional vaping device customization techniques and increasingly customized vaping experiences. However, some components of electronic vaping devices are not configurable and/or interchangeable with other electronic vaping devices. In fact, companies often create proprietary device components, proprietary pre-vapor formulations, etc. to lock users into their brand(s).

The present disclosure provides for combinable and orientable aerosolization devices or vaping devices. In this description and the following claims, “vaping devices” or “vaporizing devices” are defined to include any device (including vaporizers and E-cigarettes) configured to energize an atomizer (e.g., a heating element) to create heat and use the created heat (e.g., through conduction or convection) to transform a liquid or oil (e.g., pre-vapor formulation) into an inhalable vapor. Liquids or oils are defined to include e-juice, e-liquid, oils, tobacco, cannabis oils, dry herbs, botanical herbs, etc. An aerosolization device can also be a cartridge for holding a liquid or oil, and not necessarily be capable of being vaped without connection to one or more of a battery, a heating element, an atomizer, a mouthpiece, etc.

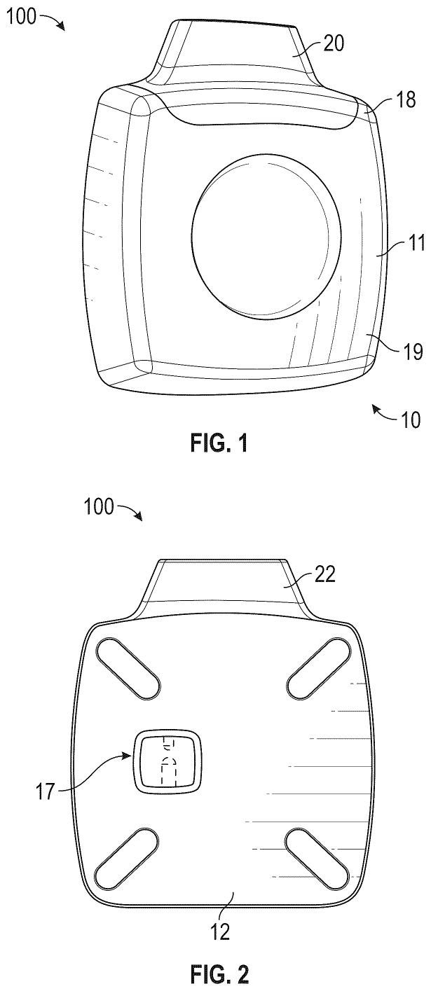

FIGS. 1 through 4 illustrate an aerosolization device 100. The aerosolization device 100 may be combinable and orientable to another vaping device 100 in a plurality of configurations and/or orientations. As illustrated, the aerosolization device 100 includes a housing 10 (e.g., an external housing) and a mouthpiece 20 connectable, attachable, or otherwise engageable with a proximal end 18 of the housing 10. The housing 10 includes a front portion 11 and a back portion 12 in connection with the front portion 11. The front portion 11 has a curved or rounded face extending between the proximal and distal ends 18, 19. The front portion 11 may include a depression 15 (FIG. 4) for tactilely orienting the aerosolization device 100 without visually looking at the aerosolization device 100.

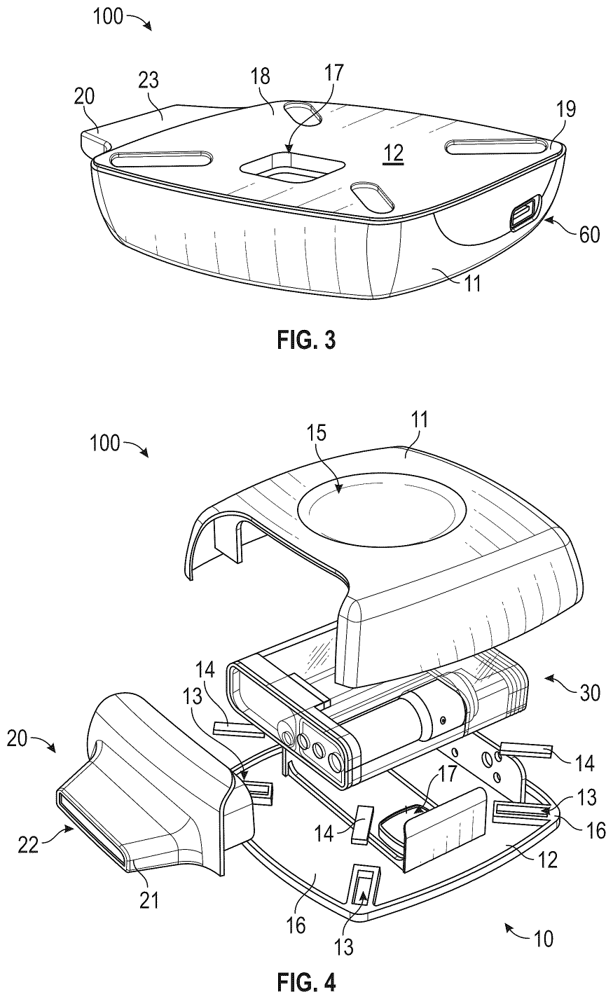

The back portion 12 has a planar or substantially planar face opposite the rounded front portion 11. As shown in FIG. 2, the back portion 12 defines or includes a window 17, which may provide a visual indication of an oil level for The aerosolization device 100 (e.g., provide a visual indication of how full a cartridge within The aerosolization device 10 is). As shown in FIG. 3, the distal end 19 of the aerosolization device 100 may include or define a port 60 (e.g., USB, USB-C, micro-USB, lightning, etc.) to facilitate charging of a power source or battery housed within the housing 10 (not illustrated).

The mouthpiece 20 includes a proximal end 21 having a vapor outlet 22 and a substantially planar back portion 23 that aligns with the back portion 12 of the housing 10. The mouthpiece 20 may be continuous with the housing 10 and/or may be a separate component connectable to the proximal end 18 of the housing 10. The substantially planar back portion 23 of the mouthpiece 20 may be flush or otherwise continuous with the substantially planar back portion 12.

Referring to FIG. 4, the housing 10 may house or otherwise receive a sled assembly 30. The sled assembly 30 may house, receive, or otherwise carry a plurality of operating components (e.g., a power source, wiring and circuitry, air flow pathways, etc.) and a cartridge for the aerosolization device 100. Additionally, the back portion 12 may interiorly define one or more slots, channels, or voids 13 for receiving one or more magnets 14 (i.e., a plurality of magnets 14). In some embodiments, the slots 13 are angularly disposed in corner regions 16 of the housing 10. For example, the housing 10 may have an overall rectangular or cuboid shape, such that the housing 10 has four (4) corner regions 16, with at least one angular slot 13 disposed in each corner region 16. Additionally, and/or alternatively, the slots 13 may be defined in sides of the housing 10 and the magnets 14 may be positioned in the sides of the housing. Slots 13 may be positioned at any suitable location and also may have the size, shape, and depth desired to receive one or more magnets 14. In some embodiments, slots 13 are not provided. Additionally, and/or alternatively, the magnets 14 may be secured to the housing 10 at the corner regions 16, or in sides of the housing 10, via adhesives, soldering, or another appropriate securement mechanism.

The magnets 14 may be “dual-polarity” magnets 14 that facilitate connection of an aerosolization device 100 to another vaping device 100 in four distinct configurations. That is, each magnet 14 includes a positive (+), or North, pole and a negative (−), or South, pole, where the magnets 14 may be split length-wise into the two poles (e.g., when the magnets 14 are bar magnets). The magnets 14 may be any suitable type of magnet that is generally able to connect to another similar type of magnet, no matter what the orientation. For example, the magnets may have a “striped” polarity, i.e., the poles are reversed in alternating stripes across the magnet 14. Electromagnets can also be used, but a non-electromagnet may be preferred for manufacturability.

The magnets 14 may be round or spherical magnets, still with a positive and negative pole split to allow them to be connected to any identical or nearly identical magnet, independent of an orientation of the magnet. Regardless of their placement within the housing 10, the one or more magnets 14 facilitate connection of the aerosolization device 100 to another vaping device 100 in a plurality of configurations. Specifically, the magnets 14 facilitate connection of the aerosolization device 100 to another vaping device 100 in three (3) or more distinct configurations, or four (4) or more distinct configurations.

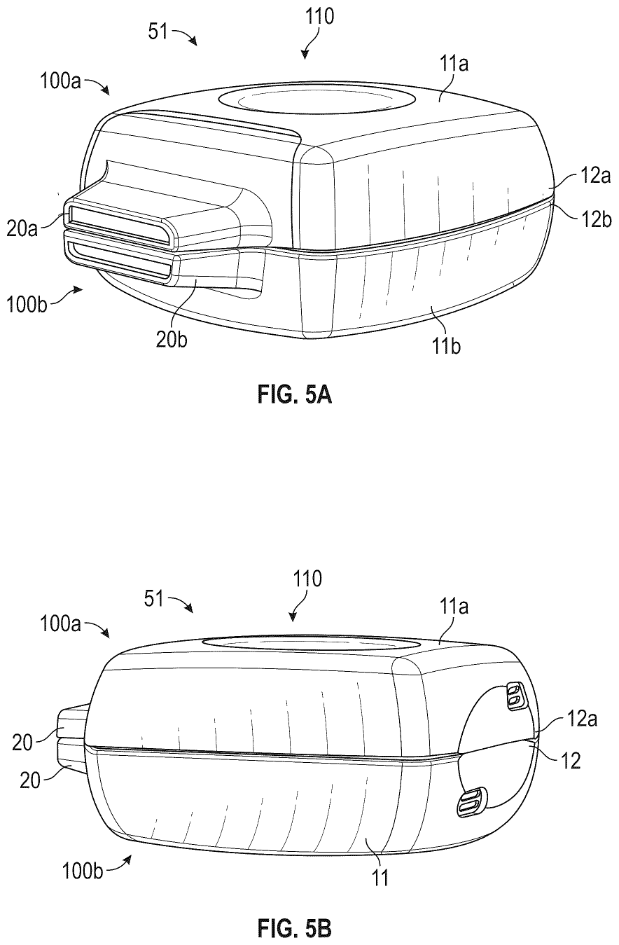

For example, FIGS. 5A and 5B illustrate a vaping system 110 in a first orientation 51, where the vaping system 110 includes a first vaping device 100a and a second vaping device 100b. The first and second vaping devices 100a, 100b may be identical or substantially identical to each other. That is, each of the first and second vaping devices 100a, 100b may include a housing 10 having a front portion 11 (e.g., a rounded front portion), a substantially planar back portion 12, and a mouthpiece 20 in association with the proximal end 18 of the housing 10.

When the first vaping device 100a is combined with or attached to the second vaping device 100b in the first orientation 51, the substantially planar back portion 12a of the first vaping device 100a abuts and rests against the substantially planar back portion 12b of the second vaping device 100b. Additionally, the mouthpiece 20a of the first vaping device 100a is adjacent to the mouthpiece 20b of the second vaping device 100b, such that a user may simultaneously vape from both the first and second vaping devices 100a, 100b. As the mouthpieces 20a, 20b are substantially flush with the substantially planar back portions 12a, 12b, the first vaping device 100a is substantially flush with the second vaping device 100b.

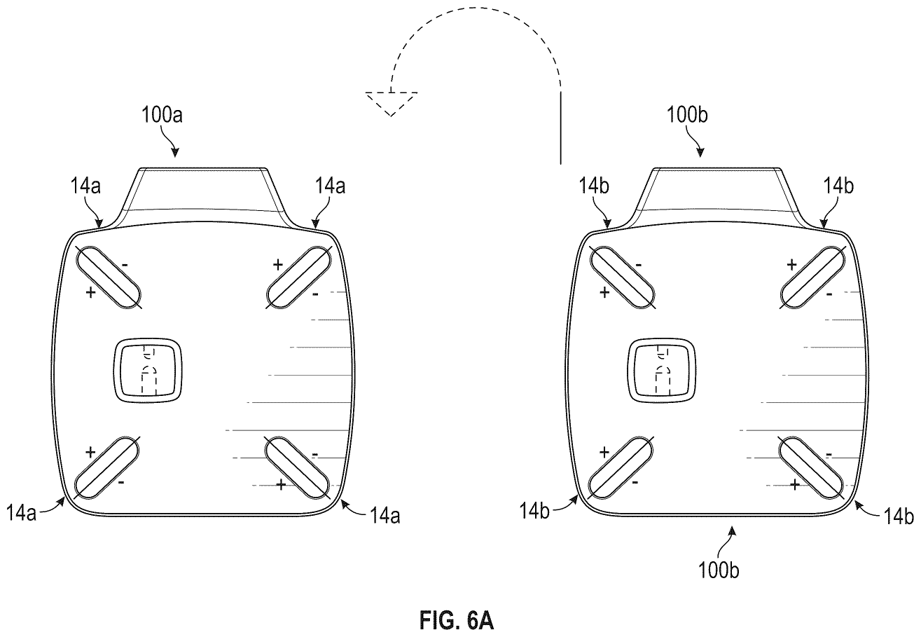

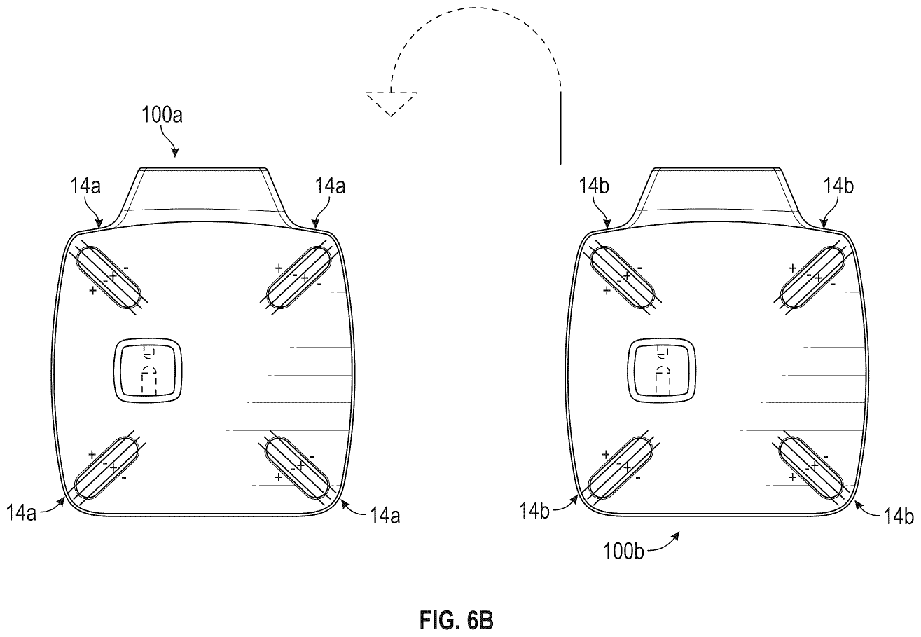

FIG. 6A illustrates one possible orientation of the plurality of magnets 14 of each vaping device 100a, 100b from the vaping system 110 of FIGS. 5A and 5B. As outlined, the first vaping device 100a is substantially identical to the second vaping device 100b, including an orientation of the magnets 14 within the housings 10 of each device 100a, 100b. As illustrated in FIG. 6A, the magnets 14 are each disposed at a corner 16 of each device 100a, 100b. When the second vaping device 100b is flipped 180° in a horizontal plane, the magnets 14b of the second vaping device 100b will align with the magnets 14a of the first vaping device 100a. When flipped, the negative poles (−) of the magnets 14b of the second vaping device 100b will align with the positive poles (+) of the magnets 14a of the first vaping device 100a, thereby securing the second vaping device 100b to the first vaping device 100a.

This alignment of the negative poles (−) of the magnets 14b of the second vaping device 100b with the positive poles (+) of the magnets 14a of the first vaping device 100a is present in each disclosed configuration. That is, no adjustments in the position of the magnets 14a, 14b are required to securely combine the first vaping device 100a to the second vaping device 100b in at least three configurations. In other embodiments, such as FIG. 6B, the magnets 14 may have further, alternating, “striped” polarity to securely combine the first vaping device 100a to the second vaping device 100b in at least four configurations.

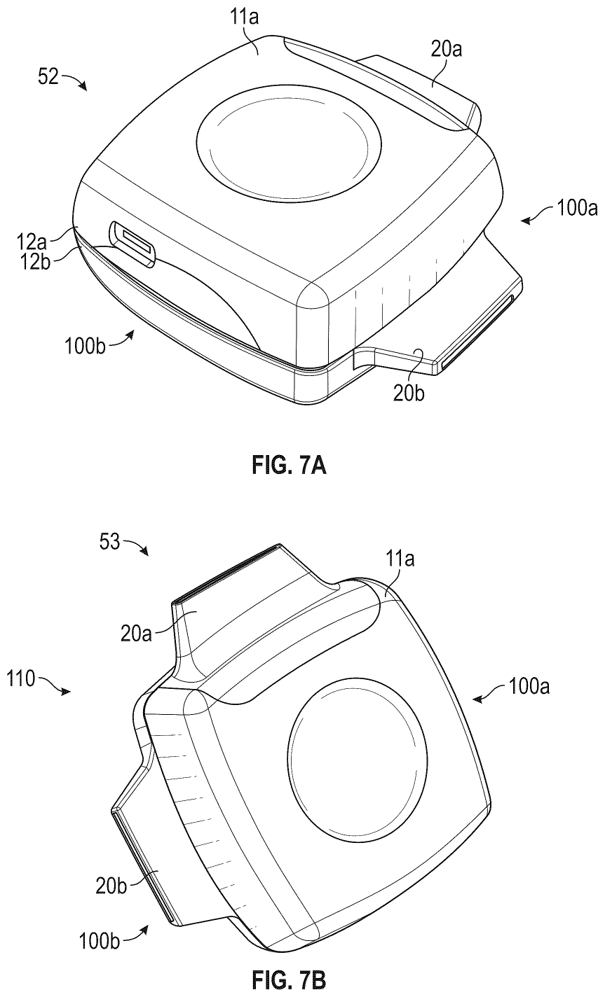

FIG. 7A illustrates the vaping system of FIGS. 5A and 5B in a second orientation 52 and FIG. 7B illustrates the vaping system of FIGS. 5A and 5B in a third orientation 53. In the second orientation 52, the mouthpiece 20b of the second vaping device 100b is right-orthogonal to the mouthpiece 20a of the first vaping device 100a. That is, the second vaping device 100b is rotated about 90° to the right (or in a first direction), relative to the first vaping device 100a. The alignment in the magnets 14a, 14b (see FIGS. 6A-6B) allows the first vaping device 100a to be magnetically secured to the second vaping device 100b in the second orientation 52.

In the third orientation 53, the mouthpiece 20b of the second vaping device 100b is left-orthogonal to the mouthpiece 20a of the first vaping device 100a. That is, the second vaping device 100b is rotated about 90° to the left (or in a second direction about 180° from the first direction), relative to the first vaping device 100a. The alignment in the magnets 14a, 14b (see FIGS. 6A-6B) allows the first vaping device 100a to be magnetically secured to the second vaping device 100b in the third orientation 53. The second vaping device 100b in the third orientation 53 is rotated about 180° from the second vaping device 100b in the second orientation 52. A user of the vaping system 110 may vape separately from either the first vaping device 100a or the second vaping device 100b in the second and third orientations 52, 53.

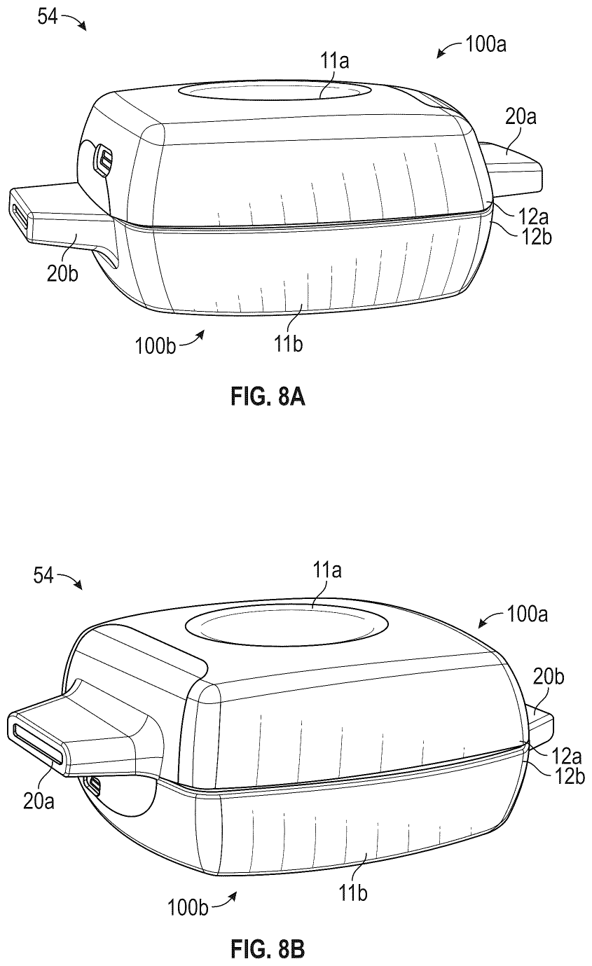

FIGS. 8A and 8B illustrate the vaping system of FIGS. 5A and 5B in a fourth orientation 54. In the fourth orientation 54, the mouthpiece 20a of the first vaping device 100a is not adjacent to the mouthpiece 20b of the second vaping device 100b. Specifically, the mouthpiece 20a of the first vaping device 100a is opposed to, or rotated about 180° from, the mouthpiece 20b of the second vaping device 100b. A user of the vaping system 110 may vape separately from either the first vaping device 100a or the second vaping device 100b in the fourth configuration 54. Magnets with striped polarity, electromagnets, etc., allow the first vaping device 100a to be magnetically secured to the second vaping device 100b in the fourth orientation 54 (i.e., substantially independent of alignment of the magnets 14).

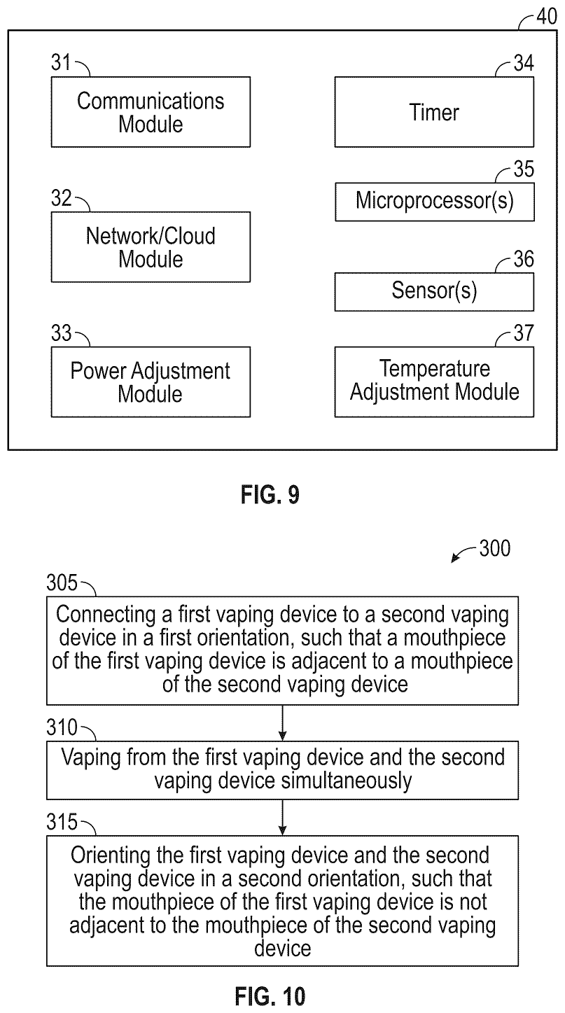

FIG. 9 schematically illustrates a block diagram of a controller 40 for use with an aerosolization device 100 and/or a vaping system 110 of the present disclosure. The controller 40 may control one or more of a voltage, a charging time, a temperature, a mobile application connectivity, an activation, and/or any other appropriate setting for the aerosolization device 100 and/or the vaping system 110. In order to control the settings, the controller 40 may include a communications module 31 allowing the controller 40 to facilitate communication with another controller 40 or other components of the aerosolization device 100 or system 110; a network or cloud module 32 to facilitate connection and/or communication with a mobile application (e.g., an application downloaded on a smart phone or other mobile device); a power adjustment module 33 to facilitate a change in voltage or resistance; a timer 34; one or more microprocessor units 35; one or more sensors 36; and a temperature adjustment module 37.

In some embodiments, the one or more sensors 36 include a microphone, a pressure sensor, a temperature sensor, and/or any other appropriate sensor. The one or more sensors 36 may also detect a presence of another vaping device 100 in a vaping system 110. Further, the one or more sensors 36 may detect an orientation 51, 52, 53, 54 of the vaping system 110. The temperature adjustment module 37 may be in communication with the power adjustment module 33 in order to control and set a temperature for vaping the oil or substance contained within a cartridge of the aerosolization device 100. In some embodiments, the temperature adjustment module 37 may be capable of independently controlling and setting a temperature for vaping the oil or substance contained within a cartridge of each vaping device 100a, 100b in a vaping system 110.

FIG. 10 is a flowchart of an example method of vaping according to the present disclosure. The method 300 may include, at 305, connecting a first vaping device to a second vaping device in a first orientation, such that a mouthpiece of the first vaping device is adjacent to a mouthpiece of the second vaping device. The method 300 may also include vaping from the first vaping device and the second vaping device simultaneously, at 310. Further, the method 300 may include orienting the first vaping device and the second vaping device in a second orientation, such that the mouthpiece of the first vaping device is not adjacent to the mouthpiece of the second vaping device, at 315.

In some embodiments, the method 300 also includes orienting the first vaping device and the second vaping device in a third orientation, such that the mouthpiece of the first vaping device is orthogonal to the mouthpiece of the second vaping device. Connecting a first vaping device to a second vaping device in a first orientation may include magnetically securing a back portion of the first vaping device to a back portion of the second vaping device. Orienting the first vaping device and the second vaping device in a second orientation may include disconnecting the first vaping device from the second vaping device, rotating the second vaping device approximately 180° relative to the first vaping device, and connecting the second vaping device, having been rotated 180°, to the first vaping device, such that the mouthpiece of the first vaping device is not adjacent to the mouthpiece of the second vaping device.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It should also be noted that some of the embodiments disclosed herein may have been disclosed in relation to a particular vaping system (e.g., independent vaping devices); however, other vaping systems (e.g., cartridges, pod systems, etc.) are also contemplated. A proximal side of an aerosolization device faces the user and the user's mouth during vaping, and a distal side or end of the aerosolization device faces away from the user during vaping.

In one embodiment, the terms “about” and “approximately” refer to numerical parameters within 10% of the indicated range. The terms “a,” “an,” “the,” and similar referents used in the context of describing the embodiments of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the embodiments of the present disclosure and does not pose a limitation on the scope of the present disclosure. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the author(s) of this disclosure for carrying out the embodiments disclosed herein. Of course, variations on these described embodiments will become apparent to those of ordinary skill in the art upon reading the foregoing description. The author(s) expects skilled artisans to employ such variations as appropriate, and the author(s) intends for the embodiments of the present disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of this disclosure so claimed are inherently or expressly described and enabled herein.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

### Embodiments

Embodiment 1. An aerosolization device comprising: a housing comprising a rounded front portion and a substantially planar back portion in connection with the front portion; a mouthpiece in connection with the housing, the mouthpiece having a rounded front portion and a substantially planar back portion aligned with the substantially planar back portion of the housing; and a plurality of magnets internally disposed within the housing, each of the plurality of magnets having a dual polarity, The aerosolization device capable of magnetic connection to a second vaping device in four (4) orientations, the second vaping device being identical to the first vaping device.
Embodiment 2. The aerosolization device of Embodiment 1, wherein each magnet of the plurality of magnets is internally disposed within a corner region of the housing.
Embodiment 3. The aerosolization device of Embodiment 2, wherein the substantially planar back portion of the housing defines an internal slot at each corner region of the housing, the internal slot for receiving a magnet of the plurality of magnets.
Embodiment 4. The aerosolization device of Embodiment 3, wherein the plurality of magnets comprise bar magnets and the internal slot is rectangular.
Embodiment 5. The aerosolization device of Embodiment 3 or Embodiment 4, wherein the plurality of magnets comprise round magnets and the internal slot is round.
Embodiment 6. The aerosolization device of any one of Embodiments 1 through 5, wherein the substantially planar back portion of the aerosolization device is connectable to a substantially planar back portion of the second vaping device in the four (4) orientations.
Embodiment 7. The aerosolization device of claim 1, wherein the mouthpiece of the aerosolization device is adjacent a mouthpiece of the second vaping device in a first orientation.
Embodiment 8. The aerosolization device of any one of Embodiments 1 through 7, wherein the mouthpiece of the aerosolization device is right-orthogonal to a mouthpiece of the second vaping device in a second orientation.
Embodiment 9. The aerosolization device of any one of Embodiments 1 through 8, wherein the mouthpiece of the aerosolization device is left-orthogonal to a mouthpiece of the second vaping device in a third orientation.
Embodiment 10. The aerosolization device of any one of Embodiments 1 through 9, wherein the mouthpiece of The aerosolization device is opposed to a mouthpiece of the second vaping device in a fourth orientation.
Embodiment 11. The aerosolization device of any one of Embodiments 1 through 10, wherein the plurality of magnets comprises at least three (3) magnets.
Embodiment 12. The aerosolization device of any one of Embodiments 1 through 11, wherein the plurality of magnets comprises four (4) magnets.
Embodiment 13. The aerosolization device of any one of Embodiments 1 through 12, wherein the housing is substantially rectangular.
Embodiment 14. A vaping system comprising: a first vaping device having a housing, a mouthpiece connected to the housing, and a plurality of dual-polarity magnets; and a second vaping device connectable to the first vaping device in four (4) orientations, the second vaping device having a housing, a mouthpiece connected to the housing, and a plurality of dual-polarity magnets for engaging the plurality of dual-polarity magnets of the first vaping device, wherein the mouthpiece of the first vaping device is aligned with and adjacent to the mouthpiece of the second vaping device when the first vaping device is connected to the second vaping device in a first orientation, wherein the mouthpiece of the first vaping device is opposite from and not adjacent to the mouthpiece of the second vaping device when the first vaping device is connected to the second vaping device in a second orientation, wherein the mouthpiece of the first vaping device is orthogonal to the mouthpiece of the second vaping device in a first direction when the first vaping device is connected to the second vaping device in a third orientation, and wherein the mouthpiece of the first vaping device is orthogonal to the mouthpiece of the second vaping device in a second direction when the first vaping device is connected to the second vaping device in a fourth orientation, the second direction being 180° away from the first direction.
Embodiment 15. The vaping system of Embodiment 14, wherein the housing of the first vaping device comprises a rounded front portion and a substantially planar back portion, the substantially planar back portion connectable to the second vaping device in each of the plurality of orientations.
Embodiment 16. The vaping system of Embodiment 15, wherein the rounded front portion of the first vaping device includes a depression for tactilely orienting the first vaping device without visually looking at the first vaping device.
Embodiment 17. The vaping system of any one of Embodiments 14 through 16, wherein the housing of the second vaping device comprises a rounded front portion and a substantially planar back portion, the substantially planar back portion connectable to the first vaping device in each of the plurality of orientations.
Embodiment 18. The vaping system of Embodiment 17, wherein the rounded front portion of the second vaping device includes a depression for tactilely orienting the second vaping device without visually looking at the second vaping device.
Embodiment 19. The vaping system of any one of Embodiments 14 through 18, wherein the first vaping device and the second vaping device can be simultaneously vaped in the first orientation.
Embodiment 20. The vaping system of any one of Embodiments 14 through 19, wherein the first vaping device can be vaped separately from the second vaping device in the second orientation.
Embodiment 21. The vaping system of any one of Embodiments 14 through 20, wherein the plurality of magnets of the first vaping device and the plurality of magnets of the second vaping device are identically oriented within the housing of the first vaping device and the housing of the second vaping device, respectively.
Embodiment 22. The vaping system of any one of Embodiments 14 through 21, wherein the plurality of magnets of the first vaping device are identical to the plurality of magnets of the second vaping device.
Embodiment 23. A vaping system comprising: a first vaping device having a housing, a mouthpiece connected to the housing, and a plurality of dual-polarity magnets; and a second vaping device connectable to the first vaping device in four (4) orientations, the second vaping device being substantially identical to the first vaping device and having a plurality of dual-polarity magnets for engaging the plurality of dual-polarity magnets of the first vaping device
Embodiment 24. A method of vaping, the method comprising: connecting a first vaping device to a second vaping device in a first orientation, such that a mouthpiece of the first vaping device is adjacent to a mouthpiece of the second vaping device; vaping from the first vaping device and the second vaping device simultaneously; orienting the first vaping device and the second vaping device in a second orientation, such that the mouthpiece of the first vaping device is not adjacent to the mouthpiece of the second vaping device; and vaping from the first vaping device separately from the second vaping device.
Embodiment 25. The method of Embodiment 24, further comprising orienting the first vaping device and the second vaping device in a third orientation, such that the mouthpiece of the first vaping device is orthogonal to the mouthpiece of the second vaping device.
Embodiment 26. The method of Embodiment 24 or Embodiment 25, wherein connecting a first vaping device to a second vaping device in a first orientation comprises magnetically securing a back portion of the first vaping device to a back portion of the second vaping device.
Embodiment 27. The method of any one of Embodiments 24 through 26, wherein orienting the first vaping device and the second vaping device in a second orientation comprises: disconnecting the first vaping device from the second vaping device; rotating the second vaping device approximately 180° relative to the first vaping device; and connecting the second vaping device, having been rotated 180°, to the first vaping device, such that the mouthpiece of the first vaping device is not adjacent to the mouthpiece of the second vaping device.
Embodiment 28. A vaping system comprising: a first vaping device having a housing, a mouthpiece connected to the housing, and a plurality of magnets; and a second vaping device connectable to the first vaping device in four (4) different orientations, the second vaping device having a plurality of magnets for engaging the plurality of magnets of the first vaping device.

What is claimed:

1. An aerosolization device comprising:
a housing comprising a rounded front portion and a substantially planar back portion in connection with the front portion;
a mouthpiece in connection with the housing, the mouthpiece having a rounded front portion and a substantially planar back portion aligned with the substantially planar back portion of the housing; and
a plurality of magnets internally disposed within the housing, each of the plurality of magnets having a dual polarity,
wherein the aerosolization device is capable of magnetic connection to a second aerosolization device in four (4) orientations, the second aerosolization device being identical to the aerosolization device.

2. The aerosolization device of claim 1, wherein each magnet of the plurality of magnets is internally disposed within a corner region of the housing.

3. The aerosolization device of claim 2, wherein the substantially planar back portion of the housing defines an internal slot at each corner region of the housing, the internal slot for receiving a magnet of the plurality of magnets.

4. The aerosolization device of claim 3, wherein the plurality of magnets comprise bar magnets and the internal slot is rectangular.

5. The aerosolization device of claim 3, wherein the plurality of magnets comprise round magnets and the internal slot is round.

6. The aerosolization device of claim 1, wherein the substantially planar back portion of the aerosolization device is connectable to a substantially planar back portion of the second aerosolization device in the four (4) orientations.

7. The aerosolization device of claim 1, wherein the mouthpiece of the aerosolization device is adjacent a mouthpiece of the second aerosolization device in a first orientation.

8. The aerosolization device of claim 1, wherein the mouthpiece of the aerosolization device is right-orthogonal to a mouthpiece of the second aerosolization device in a second orientation.

9. The aerosolization device of claim 1, wherein the mouthpiece of the aerosolization device is left-orthogonal to a mouthpiece of the second aerosolization device in a third orientation.

10. The aerosolization device of claim 1, wherein the mouthpiece of the aerosolization device is opposed to a mouthpiece of the second aerosolization device in a fourth orientation.

11. The aerosolization device of claim 1, wherein the plurality of magnets comprises at least three (3) magnets.

12. The aerosolization device of claim 1, wherein the plurality of magnets comprises four (4) magnets.

13. A vaping system comprising:
a first vaping device having a housing, a mouthpiece connected to the housing, and a plurality of dual-polarity magnets; and
a second vaping device connectable to the first vaping device in four (4) orientations, the second vaping device having a housing, a mouthpiece connected to the housing, and a plurality of dual-polarity magnets for engaging the plurality of dual-polarity magnets of the first vaping device,
wherein the mouthpiece of the first vaping device is aligned with and adjacent to the mouthpiece of the second vaping device when the first vaping device is connected to the second vaping device in a first orientation,
wherein the mouthpiece of the first vaping device is opposite from and not adjacent to the mouthpiece of the second vaping device when the first vaping device is connected to the second vaping device in a second orientation,
wherein the mouthpiece of the first vaping device is orthogonal to the mouthpiece of the second vaping device in a first direction when the first vaping device is connected to the second vaping device in a third orientation, and
wherein the mouthpiece of the first vaping device is orthogonal to the mouthpiece of the second vaping device in a second direction when the first vaping device is connected to the second vaping device in a fourth orientation, the second direction being 180° away from the first direction.

14. The vaping system of claim 13, wherein the housing of the first vaping device comprises a rounded front portion and a substantially planar back portion, the substantially planar back portion connectable to the second vaping device in each of the plurality of orientations.

15. The vaping system of claim 14, wherein the rounded front portion of the first vaping device includes a depression for tactilely orienting the first vaping device without visually looking at the first vaping device.

16. The vaping system of claim 13, wherein the first vaping device and the second vaping device can be simultaneously vaped in the first orientation.

17. The vaping system of claim 13, wherein the first vaping device can be vaped separately from the second vaping device in the second orientation.

18. The vaping system of claim 13, wherein the plurality of magnets of the first vaping device and the plurality of magnets of the second vaping device are identically oriented within the housing of the first vaping device and the housing of the second vaping device, respectively.

19. The vaping system of claim 13, wherein the plurality of magnets of the first vaping device are identical to the plurality of magnets of the second vaping device.

20. An aerosolization system comprising:
a first aerosolization device having a housing, a mouthpiece connected to the housing, and a plurality of magnets; and
a second aerosolization device connectable to the first aerosolization device in four (4) different orientations, the second aerosolization device having a plurality of magnets for engaging the plurality of magnets of the first aerosolization device.
